(19) United States
(12) Patent Application Publication
(10) Pub. No.: US 2025/0041828 A1
(43) Pub. Date: Feb. 6, 2025

(54) PROCESS FOR PRODUCING SUPERABSORBENT PARTICLES

(71) Applicant: BASF SE, Ludwigshafen (DE)

(72) Inventors: Thomas Daniel, Ludwigshafen (DE); Sebastian Marius Raupp, Ludwigshafen (DE); Monte Alan Peterson, Freeport, TX (US); Vernon Lynn Adey, Freeport, TX (US); Karl Possemiers, Antwerpen (BE)

(21) Appl. No.: 18/694,478

(22) PCT Filed: Sep. 16, 2022
(86) PCT No.: PCT/EP2022/075742

§ 371 Date: Mar. 22, 2024

(30) Foreign Application Priority Data
Sep. 27, 2021 (EP) 21199060.1

(51) Int. Cl. B01J 20/26; B01J 20/28; B01J 20/30

(52) U.S. Cl. CPC B01J 20/267; B01J 20/261; B01J 20/28047; B01J 20/3007; B01J 20/3021; B01J 20/3078; B01J 2220/68

(57) ABSTRACT

A process for producing surface postcrosslinked superabsorbent particles, wherein an aqueous monomer solution with a small amount of initiator is polymerized to give a polymer gel, the resultant polymer gel is extruded through a die plate, the extruded polymer gel is dried on an air circulation belt drier having one or more zones, and the resultant polymer particles are ground and classified and then thermally surface postcrosslinked, wherein the temperatures of the drying gas supplied in the course of drying in the forward zones of the air circulation belt drier are from 120 to 160° C., and the speeds of the air supplied are from 1.2 to 3.0 m/s.

The present invention relates to a process for producing surface postcrosslinked superabsorbent particles, wherein an aqueous monomer solution with a small amount of initiator is polymerized to give a polymer gel, the resultant polymer gel is extruded through a die plate, the extruded polymer gel is dried on an air circulation belt drier having one or more zones, and the resultant polymer particles are ground and classified and then thermally surface postcrosslinked, wherein the temperatures of the drying gas supplied in the course of drying in the forward zones of the air circulation belt drier are from 120 to 160° C., and the speeds of the drying gas supplied are from 1.2 to 3.0 m/s.

Superabsorbents are used to produce diapers, tampons, sanitary napkins and other hygiene ar-ticles, but also as water-retaining agents in market gardening. Superabsorbents are also referred to as water-absorbing polymers.

The production of superabsorbents is described in the monograph “Modern Superabsorbent Polymer Technology”, F. L. Buchholz and A. T. Graham, Wiley-VCH, 1998, pages 71 to 103.

To improve the performance properties, for example gel bed permeability (GBP) and absorption under a pressure of 49.2 g/cm² (AUL0.7 psi), superabsorbent particles are generally surface postcrosslinked. This increases the level of crosslinking of the particle surface, which can at least partly decouple the absorption under a pressure of 49.2 g/cm² (AUL0.7 psi) and the centrifuge retention capacity (CRC). This surface postcrosslinking can be performed in the aqueous gel phase. Preferably, however, polymer particles (base polymer), having been dried, ground and sieved off, are surface coated with a surface postcrosslinker and thermally surface postcrosslinked. Crosslinkers suitable for that purpose are compounds which can form covalent bonds with at least two carboxylate groups of the polymer particles.

EP 0 289 338 A2 describes a process for drying polymer gels by means of a steam-comprising gas.

EP 1 002 806 A1 describes a process for drying polymer gels in three defined drying segments.

WO 2006/100300 A1 describes a process for drying polymer gels on a belt drier with establish-ment of defined temperature profiles.

EP 2 557 095 A1, WO 2014/118024 A1 and WO 2015/169912 A1 describe processes for gentle extrusion of polymer gels for improvement of saline flow conductivity (SFC) and free swell rate (FSR).

WO 2018/114702 A1 and WO 2018/114703 A1 describe single-shaft extruders that are particularly suitable for extrusion of polymer gels.

It was an object of the present invention to provide an improved process for producing surface postcrosslinked superabsorbent particles, especially for producing surface postcrosslinked superabsorbent particles having rapid liquid absorption of 20 g/g (T20) or rapid volumetric liquid absorption under a pressure of 0.3 psi (2.07 kPa) (VAUL). In addition, the surface postcrosslinked superabsorbent particles were to have only a low residual monomer content. The sum of centrifuge retention capacity (CRC) and absorption under a pressure of 49.2 g/cm² (AUHL), by contrast, were to be at a maximum.

The object was achieved by a process for producing surface postcrosslinked superabsorbent particles by polymerizing an aqueous monomer solution or suspension comprising
a) at least one ethylenically unsaturated monomer which bears acid groups and is at least partly neutralized,
b) at least one crosslinker and
c) at least one initiator,
by polymerizing the aqueous monomer solution or suspension to give a polymer gel, extruding the resultant polymer gel through a die plate, drying the extruded polymer gel in an air circulation belt drier having one or more zones, and grinding and classifying and then thermally surface postcrosslinking the resulting polymer particles, wherein not more than 0.14% by weight of initiator c), based on monomer a), is used prior to the neutralization, the temperatures of the drying gas supplied in the forward zones of the air circulation belt drier are from 120 to 160° C. for at least 50% of the total dwell time, and the speeds of the drying gas supplied in the forward zones of the air circulation belt drier are from 1.2 to 3.0 m/s for at least 20% of the total dwell time, where the forward zones of the air circulation belt drier are the zones in the air circulation belt drier where the moisture content of the polymer gel to be dried is more than 20% by weight at least at the start of the respective zone.

The present invention is based on the finding that the liquid absorption of 20 g/g (T20) is af-fected not only by extrusion of the polymer gel prior to drying. The extractables content likewise appears to have a considerable influence. The extractables content, by contrast, can be controlled by the amount of initiator in the polymerization and the drying conditions. What is important here is that the drying is conducted at relatively low temperatures and relatively rapidly.

In a particular embodiment of the present invention, the speeds of the drying gas supplied in the forward zones of the air circulation belt drier are additionally from 0.1 to 1.15 m/s for 10% to 80% of the total dwell time in the forward zones, where the zones having the lower speeds are upstream of the zones having the higher speeds. This affords more homogeneous and better driable polymer gel layers in the air circulation belt drier.

The steam contents of the drying gas supplied in the forward zones of the air circulation belt drier are preferably at least 200 g, more preferably at least 250 g, most preferably at least 300 g, in each case per kg of dry drying gas.

The thermal surface postcrosslinking is conducted at a maximum temperature of preferably at least 180° C., more preferably at least 185° C. and most preferably at least 190° C.

Preferably not more than 0.12% by weight, more preferably not more than 0.10% by weight, especially preferably not more than 0.08% by weight, very especially preferably not more than 0.06% by weight and most preferably not more than 0.04% by weight of initiator c) is used, based in each case on monomer a) prior to neutralization.

In the forward zones of the air circulation belt drier, the temperatures of the drying gas supplied are preferably from 125 to 155° C., more preferably from 130 to 150° C., most preferably from 135 to 145° C.

In the forward zones of the air circulation belt drier, the speeds of the drying gas supplied are preferably from 1.3 to 2.8 m/s, more preferably from 1.4 to 2.6 m/s, most preferably from 1.5 to 2.4 m/s.

The forward zones of the air circulation belt drier are the zones of the air circulation belt drier where the moisture content of the polymer gel to be dried, at least at the start of the respective zone, is preferably more than 25% by weight, more preferably more than 29% by weight, most preferably more than 32% by weight.

The temperature of the polymer gel in the course of extrusion is preferably from 70 to 125° C., more preferably from 80 to 115° C. and most preferably from 90 to 105° C.

The moisture content of the polymer gel in the course of extrusion is preferably from 20% to 70% by weight, more preferably from 30% to 65% by weight, most preferably from 40% to 60% by weight.

The hole openings in the die plate have a diameter of preferably 2 to 20 mm, more preferably 4 to 15 mm, most preferably 6 to 10 mm.

The hole openings in the die plate have a length of preferably 15 to 45 mm, more preferably 20 to 40 mm and most preferably 25 to 35 mm.

The production of the superabsorbents is described in detail hereinafter:

The superabsorbents are produced by polymerizing a monomer solution or suspension, and are typically water-insoluble.

The monomers a) are preferably water-soluble, i.e. their solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

The monomers a) typically comprise polymerization inhibitors, preferably hydroquinone monomethyl ether (MEHQ), as storage stabilizer.

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Suitable crosslinkers b) are, for example, ethylene glycol dimethacrylate, diethylene glycol diacrylate, polyethylene glycol diacrylate, allyl methacrylate, trimethylolpropane triacrylate, trial-lylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 03/104299 A1, WO 03/104300 A1, WO 03/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 02/032962 A2.

The amount of crosslinker b) is preferably 0.05% to 1.5% by weight, more preferably 0.1% to 1% by weight and most preferably 0.3% to 0.6% by weight, calculated in each case on the basis of the total amounts of monomer a) used. With rising crosslinker content, the centrifuge retention capacity (CRC) falls and the absorption under a pressure of 21.0 g/cm² (AUL0.3 psi) passes through a maximum.

Initiators c) used may be all compounds which generate free radicals under the polymerization conditions, for example thermal initiators, redox initiators or photoinitiators. Suitable thermal initiators are peroxomono- and -disulfates, and peroxomono- and -diphosphates. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is preferably the disodium salt of 2-hydroxy-2-sulfonatoacetic acid or a mixture of the sodium salt of 2-hydroxy-2-sulfinatoacetic acid, the disodium salt of 2-hydroxy-2-sulfonatoacetic acid and sodium bisulfite. Such mixtures are obtainable as Bruggolite® FF6 and Bruggolite® FF7 (Bruggemann Chemicals; Heilbronn; Germany).

The amount of initiator c) is not more than 0.14% by weight, preferably not more than 0.12% by 50 weight, more preferably not more than 0.10% by weight, especially preferably not more than 0.08% by weight, very especially preferably not more than 0.06% by weight and most preferably not more than 0.04% by weight, based in each case on monomer a) prior to neutralization.

Typically, an aqueous monomer solution is used. The water content of the monomer solution is 55 preferably from 40% to 75% by weight, more preferably from 45% to 70% by weight and most preferably from 50% to 65% by weight. It is also possible to use monomer suspensions, i.e. monomer solutions with monomer a) over and above the solubility, for example sodium acrylate. As the water content rises, the energy expenditure in the subsequent drying rises and, as the water content falls, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors for the polymerization are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. It is likewise possible to use kneaders having corotatory kneader shafts. Polymerization on the belt is described, for example, in DE 38 25 366 A1 and U.S. Pat. No. 6,241,928.

The resultant polymer gel is subsequently extruded through a die plate. The hole openings in the die plate are essentially unrestricted in terms of their shape and may, for example, be circular, oval, rectangular, triangular, hexagonal, star-shaped or of irregular shape. The hole openings in the die plate are preferably circular. The diameter of the holes is preferably in the range from 2 to 20 mm, more preferably 4 to 15 mm, most preferably 6 to 10 mm. In the case of noncircular openings, the hole diameter is defined as the area-based equivalent diameter, i.e. as the diameter of a circle of the same cross-sectional area.

The length of the holes in the die plate is in the range from preferably 15 to 45 mm, more preferably from 20 to 40 mm and most preferably from 25 to 35 mm. If the holes are drillholes in the die plate, the thickness of the die plate corresponds to the length of the holes. The openings may also be implemented in the form of tubular inserts in the die plate, which may project e-yond the die plate. In this case, the hole length corresponds to the length of the inserts.

The extruder typically consists of an elongated housing, an outlet orifice provided with the die plate and at least one screw shaft which rotates within the housing and which conveys the polymer gel in the direction of the outlet orifice while generating a backpressure. In general, the polymer gel is extruded from the high pressure within the extruder through the die plate to the envi-ronment. In order to prevent excessive cooling or heating of the polymer gel during the extrusion, the extruder is preferably trace-heated as required, more preferably with steam, or trace-cooled. The extrusion can be conducted either continuously or batchwise.

Particularly suitable extruders are described, for example, in WO 2018/114702 A1 and WO 2018/114703 A1.

If the polymerization is conducted in a kneading reactor, the pressure drop across the die plate in the extrusion is preferably from 5 to 45 bar, more preferably from 10 to 40 bar, most preferably from 15 to 35 bar, and the opening ratio of the die plate is preferably from 5.0% to 50%, more preferably from 7.5% to 30%, most preferably from 10.0% to 20%. The opening ratio is defined as the ratio of the open area (sum of the hole areas) of the die plate to the maximum utilizable area of the die plate.

If the polymerization is conducted by means of a belt reactor, the pressure drop across the die plate in the extrusion is preferably from 3 to 15 bar, more preferably from 4 to 14 bar, most preferably from 5 to 13 bar, and the opening ratio of the die plate is preferably from 35% to 75%, more preferably from 40% to 70%, most preferably from 45% to 65%. The opening ratio is defined as the ratio of the open area (sum of the hole areas) of the die plate to the maximum utilizable area of the die plate.

The polymer gel undergoes a mechanical energy input in the extrusion, particularly through the action of the rotating screw shaft(s). Excessively high energy inputs lead to damage to the inner structure of the polymer gel.

The energy input can be influenced, for example, via the ratio of internal length to internal diameter of the extruder (LID). The ratio of internal length to internal diameter of the extruder is preferably 1 to 6.0, more preferably 2 to 5.5, most preferably 3 to 5.0.

The specific mechanical energy (SME) introduced in the course of extrusion is preferably from 2.5 to 60 kWh/t, more preferably from 5.0 to 50 kWh/t and most preferably from 10.0 to 40 kWh/t. The specific mechanical energy (SME) is the motor output of the extruder in kW divided by the throughput of polymer gel in t/h. This avoids damage to the polymer gel in the course of extrusion.

During the extrusion, the polymer gel has a temperature within the range from preferably 70 to 125° C., more preferably 80 to 115° C., most preferably 90 to 105° C.

The moisture content of the polymer gel prior to passage through the die plate is preferably from 20% to 70% by weight, more preferably from 30% to 65% by weight, most preferably from 40% to 60% by weight. Since the extrusion may be associated with the evaporation of water, there is generally a drop in the moisture content of the polymer gel during extrusion. The ratio of the moisture content of the polymer gel after passage through the die plate to the moisture content of the polymer gel before passage through the die plate (FGₚosₜ-eₓₜr/FGₚre-eₓₜr) is preferably at least 0.99, more preferably at least 0.95, most preferably at least 0.91.

The acid groups of the polymer gel have typically been partly neutralized. Neutralization is preferably carried out at the monomer stage. This is typically accomplished by mixing in the neutralizing agent as an aqueous solution or else preferably as a solid. The degree of neutralization is preferably from 40 to 85 mol %, more preferably from 50 to 80 mol % and most preferably from 60 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof. Solid carbonates and hydrogencarbonates can also be introduced here in encapsulated form, preferably into the monomer solution directly prior to the polymerization, into the polymer gel during or after the polymerization and prior to the drying thereof. The encapsulation is effected by coating of the surface with an insoluble or only gradually soluble material (for example by means of film-forming polymers, of inert inorganic materials or of fusible organic materials) which delays the dissolution and reaction of the solid carbonate or hydrogencarbonate to such a degree that carbon dioxide is not released until during the drying and the superabsorbent formed has high internal porosity.

The extruded polymer gel is then dried with an air circulation belt drier having one or more zones until the moisture content is preferably 0.5 to 10% by weight, more preferably 1 to 7% by weight and most preferably 2 to 5% by weight, the moisture content being determined by EDANA recommended test method No. WSP 230.2-05 “Mass Loss Upon Heating”. The zones of the air circulation belt drier are spatially separate regions in which the drying conditions, such as temperature, speed and humidity of the drying gas, can be adjusted individually. The monograph “Modern Superabsorbent Polymer Technology”, F. L. Buchholz and A. T. Graham, Wiley-VCH, 1998, page 89, FIG. 3.6, shows an air circulation belt drier having five zones and one cooling zone. In the case of too high a humidity, the dried polymer gel has too low a glass tran-sition temperature Tg and can be processed further only with difficulty. In the case of too low a humidity, the dried polymer gel is too brittle and, in the subsequent comminution steps, undesir-ably large amounts of polymer particles with an excessively low particle size are obtained (“fines”). The moisture content of the polymer gel before the drying is preferably from 20% to 70% by weight, more preferably from 30% to 65% by weight, most preferably from 40% to 60% by weight. Subsequently, the dried polymer gel is crushed and optionally coarsely comminuted.

For a rapid liquid absorption of 20 g/g (T20), the drying conditions in the forward zones of the air circulation belt drier are crucial. The forward zones of the air circulation belt drier are the zones where the moisture content of the polymer gel to be dried, at least at the start of the respective zone, is more than 20% by weight, preferably more than 25% by weight, more preferably at 50 least 29% by weight, most preferably at least 32% by weight.

In the forward zones of the air circulation belt drier, the temperatures of the drying gas supplied, to an extent of at least 50%, preferably to an extent of at least 60%, more preferably to an extent of at least 70%, most preferably to an extent of at least 80%, of the total dwell time in the 55 forward zones, are from 120 to 160° C., preferably from 125 to 155° C., more preferably from 130 to 150° C., most preferably from 135 to 145° C.

In the forward zones of the air circulation belt drier, the speeds of the drying gas supplied, to an extent of at least 20%, preferably to an extent of at least 30%, more preferably to an extent of at least 40%, most preferably to an extent of at least 50%, of the total dwell time in the forward zones, are from 1.2 to 3.0 m/s, preferably from 1.3 to 2.8 m/s, more preferably from 1.4 to 2.6 m/s, most preferably from 1.5 to 2.4 m/s.

The number of forward zones is not subject to any restriction. If all zones meet the condition for the moisture content because the air circulation belt drier, for example, has just a single zone, the forward zones in the context of this invention comprise the entire air circulation belt drier.

In a particular embodiment of the present invention, lower speeds of the drying gas supplied are established in the first zones of the air circulation belt drier. In the forward zones of the air circulation belt drier, the speeds of the drying gas supplied are then additionally, to an extent of 10% to 50%, preferably to an extent of 15% to 70%, more preferably to an extent of 20% to 60%, most preferably to an extent of 25% to 50%, of the total dwell time in the forward zones, from 0.1 to 1.15 m/s, preferably from 0.3 to 1.10 m/s, more preferably from 0.5 to 1.05 m/s, most preferably from 0.7 to 1.00 m/s.

If an air circulation belt drier has a total of 10 zones and the dwell time in each zone is 5 minutes and the starting value for the moisture content of the polymer gel to be dried is satisfied only in the first four zones, the total dwell time in the forward zones is 20 minutes.

If the speed of the drying gas supplied, in the particular embodiment, is 1.00 m/s in the first zone and 2.0 m/s in the three zones downstream, the dwell time is calculated at a speed of the drying gas supplied of 1.00 m/s for 25% of the total dwell time in the forward zones, and the dwell time at a speed of the drying gas supplied of 2.0 m/s for 75% of the total dwell time in the forward zones.

The flow of air onto the polymer gel to be dried in the air circulation belt drier may be from the top or from the bottom. For uniform drying, it is appropriate for the flow of air onto the polymer gel to be dried to be firstly from the bottom for about ⅓ of the dwell time in the air circulation belt drier, and then for the flow of air onto the polymer gel to be dried to be from the top. Such a procedure and the advantages thereof are described in WO 2006/100300 A1.

Suitable drying gases are, for example, air, nitrogen and air-nitrogen mixtures. The drying could alternatively be conducted with superheated steam as drying gas, as described in chapter 19, “Superheated Steam Drying”, of the “Handbook of Industrial Drying”, 3rd edition, 2006, ISBN 9781420017618.

In the forward zones of the air circulation belt drier, the water vapor contents should, to an extent of at least 50%, preferably to an extent of at least 60%, more preferably to an extent of at least 70%, most preferably to an extent of at least 80%, of the dwell time in the forward zones, preferably be at least 200 g, more preferably at least 250 g, most preferably at least 300 g, in each case per kg of dry drying gas. This results in better degradation of unconverted monomers a) during the drying.

The water vapor content of the drying gas supplied can be achieved by active supply of water via nozzles or atomizers, by supply of water vapor, or by moistening the drying material. It is likewise possible to generate the water vapor content wholly or partly from the drying material itself, for example in that the fresh air supply is controlled correspondingly and the ventilation of the drying material itself is adjusted appropriately. For example, in the forward zones, it is possible to utilize a low drying temperature, a reduced fresh air supply and a slowed flow through the drying material.

Thereafter, the dried polymer gel is typically ground and classified, and the apparatus used for 50 grinding may typically be single- or multistage roll mills, preferably two- or three-stage roll mills, pin mills, hammer mills or vibratory mills.

The mean particle size of the polymer particles removed as the product fraction is preferably at least 200 μm, more preferably from 250 to 600 μm and very particularly from 300 to 500 μm. The average particle size of the product fraction may be determined by means of EDANA recommended test method No. WSP 220.2-05 “Particle Size Distribution”, where the proportions by mass of the screen fractions are plotted in cumulated form and the average particle size is determined graphically. The average particle size here is the value of the mesh size which arises for a cumulative 50% by weight.

The proportion of particles having a particle size of greater than 150 μm is preferably at least 90% by weight, more preferably at least 95% by weight and most preferably at least 98% by weight.

Polymer particles with too small a particle size lower the permeability (SFC). The proportion of excessively small polymer particles (“fines”) should therefore be small.

Excessively small polymer particles are therefore typically removed and recycled into the process. This is preferably accomplished before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

If a kneading reactor is used for polymerization, the excessively small polymer particles are preferably added during the last third of the polymerization.

If the excessively small polymer particles are added at a very early stage, for example actually to the monomer solution, this lowers the centrifuge retention capacity (CRC) of the resulting wa-ter-absorbing polymer particles. However, this can be compensated, for example, by adjusting the amount of crosslinker b) used.

If the excessively small polymer particles are added at a very late stage, for example not until an apparatus connected downstream of the polymerization reactor, for example an extruder, the excessively small polymer particles can be incorporated into the resulting polymer gel only with difficulty. Inadequately incorporated, excessively small polymer particles are, however, de-tached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles of excessively large particle size lower the free swell rate. The proportion of excessively large polymer particles should therefore likewise be low.

Excessively large polymer particles are therefore typically removed and recycled into the grinding of the dried polymer gel.

To further improve the properties, the polymer particles are thermally surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230. Particularly suitable surface postcrosslinkers are ethylene carbonate and derivatives thereof, and 2-oxazolidone and derivatives thereof. Particular preference is given to ethylene carbonate and N-(2-hydroxyethyl)-2-oxazolidinone.

The amount of surface postcrosslinker is preferably 0.001% to 2% by weight, more preferably 0.02% to 1% by weight and most preferably 0.05% to 0.2% by weight, based in each case on the polymer particles.

As well as the surface postcrosslinkers, it is possible to apply polyvalent cations to the particle surface.

The polyvalent cations usable in the process of the invention are, for example, divalent cations such as the cations of zinc, magnesium, calcium and strontium, trivalent cations such as the cations of aluminum, iron, chromium, rare earths and manganese, tetravalent cations such as the cations of titanium and zirconium. Possible counterions are chloride, bromide, hydroxide, sulfate, hydrogensulfate, carbonate, hydrogencarbonate, nitrate, phosphate, hydrogenphosphate, dihydrogenphosphate and carboxylate, such as acetate and lactate. Aluminum hydroxide, aluminum sulfate and aluminum lactate are preferred.

The amount of polyvalent cation used is, for example, 0.001% to 1.5% by weight, preferably 0.005% to 1% by weight and more preferably 0.02% to 0.8% by weight, based in each case on the polymer.

The surface postcrosslinking is typically performed in such a way that a solution of the surface postcrosslinker is sprayed onto the dried polymer particles. After the spray application, the surface postcrosslinker-coated polymer particles are subjected to thermal treatment.

The spray application of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the po-sition of the mixing shaft, i.e. horizontal mixers have a horizontally mounted mixing shaft and vertical mixers have a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The penetra-tion depth of the surface postcrosslinker into the polymer particles can be adjusted via the content of nonaqueous solvent and total amount of solvent.

The thermal treatment is preferably conducted in contact driers, more preferably paddle driers, most preferably disk driers. Suitable driers are, for example, Hosokawa Bepex® Horizontal Paddle Dryer (Hosokawa Micron GmbH; Leingarten; Germany), Hosokawa Bepex® Disk Dryer (Hosokawa Micron GmbH; Leingarten; Germany), Holo-Flite® driers (Metso Minerals Industries Inc.; Danville; USA) and Nara Paddle Dryer (NARA Machinery Europe; Frechen; Germany).

Moreover, fluidized bed driers may also be used.

The surface postcrosslinking can be effected in the mixer itself, by heating the jacket or blowing in warm air. Equally suitable is a downstream drier, for example a tray drier, a rotary tube oven or a heatable screw. It is particularly advantageous to effect mixing and thermal surface postcrosslinking in a fluidized bed drier.

The reaction temperatures are in the range from preferably 180 to 250° C., more preferably 185 to 220° C., most preferably from 190 to 210° C. The preferred dwell time at this temperature is preferably at least 10 minutes, more preferably at least 20 minutes, most preferably at least 30 minutes, and typically at most 60 minutes.

Given correspondingly high reaction temperatures, particularly high values for the sum total of centrifuge retention capacity (CRC) and absorption under a pressure of 49.2 g/cm² (AUHL) are attained.

If surface postcrosslinkers having epoxy groups are used, for example ethylene glycol diglycidyl 50 ether, the temperature in the surface postcrosslinking may even be much lower.

Subsequently, the surface postcrosslinked polymer particles can be classified again, with excessively small and/or excessively large polymer particles being removed and recycled into the process. To further improve the properties, the surface postcrosslinked polymer particles can be coated or remoisturized.

The remoisturizing is preferably performed at 30 to 80° C., more preferably at 35 to 70° C., most 60 preferably at 40 to 60° C. At excessively low temperatures the polymer particles tend to form lumps, and at higher temperatures water already evaporates to a noticeable degree. The amount of water used for remoisturizing is preferably from 1% to 10% by weight, more preferably from 2% to 8% by weight and most preferably from 3% to 5% by weight. The remoisturizing increases the mechanical stability of the polymer particles and reduces their tendency to static charging. The remoisturizing is advantageously performed in a cooler after the thermal surface postcrosslinking.

Suitable coatings for improving the swell rate and the gel bed permeability (GBP) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, precipitated silica, such as Sipernat® D17, and surfactants, such as Span® 20.

Methods:

The standard test methods described hereinafter and designated “WSP” are described in: “Standard Test Methods for the Nonwovens Industry”, 2005 edition, published jointly by the Worldwide Strategic Partners EDANA (Herrmann-Debrouxlaan 46, 1160 Oudergem, Belgium, www.edana.org) and INDA (1100 Crescent Green, Suite 115, Cary, North Carolina 27518, USA, www.inda.org). This publication is obtainable both from EDANA and from INDA.

The measurements should, unless stated otherwise, be conducted at an ambient temperature of 23±2° C. and a relative air humidity of 50%±10%. The superabsorbent particles are mixed thoroughly before the measurement.

### Residual Monomers

The residual monomer content is determined by EDANA recommended test method No. 210.2 (05) “Residual Monomers”.

### Moisture Content

Moisture content is determined by EDANA recommended test method No. WSP 230.2 (05) “Mass Loss Upon Heating”. In the case of moisture contents exceeding 5% by weight, the drying time at 105±2° C. should be extended until constant weight.

The moisture content of the polymer gel to be dried is determined by drying 1.0 to 1.5 kg of polymer gel to constant weight at 105±2° C. The drying can be accelerated by intermediately com-minuting the polymer gel.

In the case of relatively small amounts, for example in the case of drying in a belt drier simulator, it is also possible to conduct intermediate weighing operations with the total amount of polymer gel. The amount of polymer gel in this case may also be less than 1.0 kg. In the last step, drying is effected to constant weight at 105±2° C. The moisture content of the polymer gel in the intermediate weighing operations is then ascertained by calculation.

### Centrifuge Retention Capacity

Centrifuge retention capacity (CRC) is determined by EDANA recommended test method No. WSP 241.2 (05) “Fluid Retention Capacity in Saline, After Centrifugation”.

Absorption Under a Pressure of 21.0 g/cm² (Absorption Under Load)

Absorption under a pressure of 21.0 g/cm² (AUL0.3 psi) is determined by EDANA recommended test method No. WSP 242.205 “Absorption Under Pressure, Gravimetric Determination”.

Absorption Under a Pressure of 49.2 g/cm² (Absorption Under High Load)

Absorption under a pressure of 49.2 g/cm² (AUHL) is determined analogously to EDANA recommended test method No. WSP 242.2 (05) “Absorption Under Pressure, Gravimetric Determination”, except that a pressure of 49.2 g/cm² (0.7 psi) is established rather than a pressure of 21.0 g/cm² (0.3 psi).

### Extractables

The content of extractables of the water-absorbing polymer particles is determined by EDANA recommended test method No. WSP 270.2 (05) “Extractable”.

### Liquid Absorption of 20 g/g (T20)

Liquid absorption of 20 g/g (T20) is determined by the “K(t) Test Method (Dynamic Effective Permeability and Uptake Kinetics Measurement Test Method)” described in EP 2 535 027 A1 on pages 13 to 18.

Volumetric Absorption of Liquid Under a Pressure of 0.3 Psi (2.07 kPa) (VAUL)

For the volumetric absorption of liquid under a pressure of 0.3 psi (2.07 kPa) (VAUL), the T value is determined by the “Volumetric Absorbency Under Load (VAUL)” test method described in EP 2 922 882 B1 on page 22. The T value is referred to therein as “characteristic swelling time”.

### Saline Flow Conductivity

Saline flow conductivity (SFC) is determined by the “Urine Permeability Measurement (UPM) Test method” test method described in EP 2 535 698 A1 on pages 19 to 22.

### EXAMPLES

### Examples 1 to 13

Polymerization:

By continuously mixing deionized water, 50% by weight sodium hydroxide solution and acrylic acid, an acrylic acid/sodium acrylate solution is prepared such that the degree of neutralization corresponds to 71.0 mol %. The solids content of the monomer solution is 41.0% by weight.

The crosslinker b) used is 3-tuply ethoxylated glyceryl triacrylate (purity about 85% by weight). The amount used is 0.45% by weight, based on acrylic acid used. In addition, the monomer solution comprises 0.75% by weight of polyethylene glycol-4000 (polyethylene glycol having an average molar mass of 4000 g/mol), based on acrylic acid used.

The free-radical polymerization is initiated using 0.0005% to 0.0020% by weight of hydrogen peroxide, 0.06% to 0.15% by weight of sodium peroxodisulfate and 0.0076% by weight of ascorbic acid, based in each case on acrylic acid used. The exact conditions of the individual examples can be found in table 1.

The monomer solution is introduced into a List Contikneter continuous kneader reactor with a capacity of 6.3 m³ (LIST A G, Arisdorf, Switzerland). The throughput of the monomer solution is about 20 t/h.

Between the addition point for the crosslinker and the addition sites for the hydrogen peroxide 50 and sodium peroxodisulfate solutions, the monomer solution is inertized with nitrogen. Ascorbic acid is metered directly into the reactor.

After about 50% of the dwell time, an additional about 1200 kg/h of polymer particles obtained in the production process by comminution and classification, having a particle size of less than 150 μm, is metered into the reactor. The dwell time of the reaction mixture in the reactor is about 15 minutes.

Extrusion:

The resultant polymer gel is metered into a 650 EX extruder (ECT-KEMA GmbH, Girbigsdorf, Germany).

The temperature of the polymer gel in the course of extrusion is about 115 to 130°. The die plate has 2764 holes having a hole diameter of 8 mm. The thickness of the die plate is 33 mm.

The opening ratio of the die plate is 42%. The ratio of internal length to internal diameter of the extruder (L/D) is 4. The pressure drop across the die plate is about 27 to 28 bar.

Drying:

Samples of the polymer gel are taken while still hot and loosely layered in a stationary belt drier simulator.

The belt drier simulator is a cylindrical stainless steel pot with a sieve plate. The flow of drying air through the polymer gel here is either from the bottom or from the top. It is possible to control the direction, temperature, humidity (injection of steam) and amount (=speed) of the drying air. The simulator is programmable and can generate different arbitrary drying profiles successively—even with regard to the progression of a drying operation over time. The belt drier simulator can simulate drying in an air circulation belt drier having one or more zones.

In the introduction of the polymer gel, it should be ensured that the drying air can flow through the porous polymer gel bed. The height of the polymer gel bed is 9 cm. For this purpose, 1285 g of extruded polymer gel is required.

The polymer gel is dried for 25 minutes. The flow of air through the polymer gel is at first from the bottom for ⅓ of the time and then from the top. The temperature of the dry air is 135 to 170° C. The speed of the dry air is 1.0 to 2.0 m/s. The drying air comprises 100 to 700 g of water vapor per kg of dry air. The exact conditions of the individual examples can be found in table 1.

Comminution and Classification:

The dried polymer gel is coarsely comminuted, ground by means of a three-stage roll mill and sieved off to a particle size of 150 to 700 μm. The sieving-off is effected such that at least 95% by weight of the polymer particles have a particle size of 150 to 700 μm.

TABLE 1
Process conditions for the base polymer

| | NaPS | H₂O₂ | | T | v | Humidity |
|---|---|---|---|---|---|---|
| Example | [% by wt.] | [% by wt.] | Extrusion | [° C.] | [m/s] | [g/kg] |
| 1*) | 0.15 | 0.0020 | yes | 140 | 2.0 | 100 |
| 2*) | 0.15 | 0.0020 | yes | 140 | 2.0 | 300 |
| 3*) | 0.15 | 0.0020 | yes | 140 | 2.0 | 100 |
| 4*) | 0.15 | 0.0020 | no | 140 | 2.0 | 100 |
| 5*) | 0.15 | 0.0020 | yes | 170 | 2.0 | 100 |
| 6*)**) | 0.15 | 0.0020 | yes | 170 | 1.0 | 100 |
| 7*)***) | 0.15 | 0.0020 | yes | 170 | 1.0 | 100 |
| 8 | 0.11 | 0.0020 | yes | 140 | 2.0 | 100 |
| 9 | 0.13 | 0.0010 | yes | 140 | 1.5 | 300 |
| 10 | 0.09 | 0.0005 | yes | 150 | 1.6 | 450 |
| 11 | 0.06 | 0.0005 | yes | 145 | 1.8 | 700 |
| 12 | 0.08 | 0.0005 | yes | 135 | 1.8 | 375 |
| 13 | 0.08 | 0.0005 | yes | 135 | 1.8 | 275 |

NaPS sodium peroxodisulfate based on acrylic acid used
H₂O₂ hydrogen peroxide based on acrylic acid used
T temperature of the dry air
v speed of the dry air
Humidity humidity of the dry air
*)comparative example
**)not completely dried
***)dried for 60 minutes

TABLE 2
Properties of the base polymer

| | CRC | AUL | Extractables |
|---|---|---|---|
| Example | [g/g] | [g/g] | [% by wt.] |
| 1*) | 34.4 | 18.5 | 12.8 |
| 2*) | 34.7 | 18.7 | 12.5 |
| 3*) | 34.4 | 18.5 | 12.8 |
| 4*) | 36.6 | 17.8 | 14.6 |
| 5*) | 36.3 | 16.5 | 14.9 |
| 6*)**) | | | |
| 7*)***) | 37.6 | 15.1 | 15.6 |
| 8 | 33.9 | 18.5 | 10.1 |
| 9 | 34.2 | 18.1 | 10.6 |
| 10 | 33.8 | 18.5 | 8.9 |
| 11 | 33.1 | 19.0 | 7.5 |
| 12 | 34.0 | 18.6 | 9.1 |
| 13 | 33.5 | 18.9 | 8.5 |

*)comparative example
**)not completely dried
***)dried for 60 minutes

Surface Postcrosslinking:

1.2 kg of classified polymer particles is coated in a VT 5R-MK plowshare mixer with heating jacket (from Lödige Maschinenbau GmbH; Paderborn, Germany) at 23° C. and a shaft speed of 200 revolutions per minute by means of a two-phase spray nozzle with a mixture of 1.41% by weight of isopropanol, 3.13% by weight of water, 0.07% by weight of N-hydroxyethyl-2-oxazolidinone, 0.07% by weight of propane-1,3-diol and 0.5% by weight of aluminum lactate (solution A) or a mixture of 2.54% by weight of water and 2.00% by weight of ethylene carbonate (solution B), based in each case on the polymer particles used. The exact conditions of the individual examples can be found in table 3.

After the spray application, the product temperature is increased to from 175 to 185° C. and the reaction mixture is held at this temperature and a shaft speed of 50 revolutions per minute for 45 minutes. The resulting product is cooled to ambient temperature and classified again with a 700 μm sieve. The fraction with a particle size of less than 700 μm is analyzed. The results are entered in table 3.

TABLE 3
Process conditions and results of the surface postcrosslinking

| | | | | | | SFC | Remos |
|---|---|---|---|---|---|---|---|
| | | T | CRC | AUHL | T20 | [10⁻⁷ | [% by |
| Example | Solution | [° C] | [g/g] | [g/g] | [s] | cm³s/g] | wt.] |
| 1*) | A | 185 | 26.9 | 26.0 | 137 | 39 | 0.076 |
| 2*) | A | 185 | 27.0 | 25.8 | 135 | 33 | 0.055 |
| 3*) | A | 175 | 25.9 | 25.1 | 140 | 32 | 0.070 |
| 4*) | A | 185 | 26.5 | 24.5 | 235 | 29 | 0.043 |
| 5*) | A | 185 | 26.2 | 24.1 | 153 | 27 | 0.057 |
| 6*)**) | | | | | | | |
| 7*) | A | 185 | 25.9 | 24.2 | 167 | 20 | 0.043 |
| 8 | A | 185 | 27.2 | 25.9 | 125 | 35 | 0.085 |
| 9 | A | 185 | 28.4 | 26.2 | 121 | 29 | 0.049 |
| 10 | A | 185 | 30.7 | 27.7 | 113 | 30 | 0.032 |
| 11 | A | 185 | 30.6 | 27.8 | 109 | 35 | 0.029 |
| 12 | A | 185 | 29.8 | 26.8 | 117 | 38 | 0.040 |
| 13 | B | 185 | 30.9 | 27.1 | 109 | 34 | 0.050 |

T surface postcrosslinking temperature
Remos residual monomer
*)comparative example
**)not completely dried
***) dried for 60 minutes

Comparison of example 8 with example 1 shows the improvement in T20 as a result of lowering of the amount of initiator used in the polymerization.

Comparison of example 1 with example 4 shows the improvement in T20 as a result of extrusion prior to the drying.

Comparison of example 1 with example 5 shows the improvement in T20 as a result of lowering of the temperature of the dry air.

Comparison of example 5 with example 6 shows the slowing of the drying when dry air speeds are too low.

Comparison of example 5 with example 7 shows the improvement in T20 as a result of increasing the dry air speeds.

Comparison of example 2 with example 1 shows the improvement in the residual monomer content as a result of increasing the water vapor content of the dry air.

Comparison of example 1 with example 3 shows the improvement in the sum total of CRC and AUHL as a result of increasing the temperature in the thermal surface postcrosslinking.

Inventive examples 8 to 13 have a T20 that is at least 12 s better than examples 1 to 6 (compar-ative examples).

### Examples 14 to 18

Polymerization:

By continuously mixing deionized water, 50% by weight sodium hydroxide solution and acrylic acid, an acrylic acid/sodium acrylate solution is prepared such that the degree of neutralization corresponds to 71.0 mol %. The solids content of the monomer solution is 41.0% by weight.

The crosslinker b) used is 3-tuply ethoxylated glyceryl triacrylate (purity about 85% by weight). The amount used is 0.45% by weight, based on acrylic acid used. In addition, the monomer solution comprises 0.75% by weight of polyethylene glycol-4000 (polyethylene glycol having an average molar mass of 4000 g/mol), based on acrylic acid used.

The free-radical polymerization is initiated using 0.0005% by weight of hydrogen peroxide, 0.06% by weight of sodium peroxodisulfate and 0.0076% by weight of ascorbic acid, based in each case on acrylic acid used. The exact conditions of the individual examples can be found in table 1.

The monomer solution is introduced into a List Contikneter continuous kneader reactor with a capacity of 6.3 m³ (LIST A G, Arisdorf, Switzerland): The throughput of the monomer solution is about 20 t/h.

Between the addition point for the crosslinker and the addition sites for the hydrogen peroxide and sodium peroxodisulfate solutions, the monomer solution is inertized with nitrogen. Ascorbic acid is metered directly into the reactor.

After about 50% of the dwell time, an additional about 1200 kg/h of polymer particles obtained in the production process by comminution and classification, having a particle size of less than 150 μm, is metered into the reactor. The dwell time of the reaction mixture in the reactor is about 15 minutes.

Extrusion:

The resultant polymer gel is metered into a 650 EX extruder (ECT-KEMA GmbH, Girbigsdorf, Germany).

The temperature of the polymer gel in the course of extrusion is about 115 to 130°. The die plate has 2764 holes having a hole diameter of 8 mm. The thickness of the die plate is 33 mm.

The opening ratio of the die plate is 42%. The ratio of internal length to internal diameter of the extruder (L/D) is 4. The pressure drop across the die plate is about 27 to 28 bar.

Drying:

Samples of the polymer gel are taken while still hot and loosely layered in a stationary belt drier simulator.

The belt drier simulator is a cylindrical stainless steel pot with a sieve plate. The flow of drying air through the polymer gel here is either from the bottom or from the bottom. It is possible to control the direction, temperature, humidity (injection of steam) and amount (=speed) of the drying air. The simulator is programmable and can generate different arbitrary drying profiles successively—even with regard to the progression of a drying operation over time. The belt drier simulator can simulate drying in an air circulation belt drier having one or more zones.

In the introduction of the polymer gel, it should be ensured that the drying air can flow through the porous polymer gel bed. The height of the polymer gel bed is 9 cm. For this purpose, 1285 g of extruded polymer gel is required.

The polymer gel is dried for 25 minutes. The flow of air through the polymer gel is at first from the bottom in the first three zones and then from the top. The dwell time in each zone is 2.5 minutes. The last zone is a cooling zone. The temperature of the dry air is 140 to 198° C. The speed of the dry air is 1.0 to 2.0 m/s. The drying air comprises 75 to 350 g of water vapor per kg of dry air. The exact conditions of the individual examples can be found in table 4.

Comminution and Classification:

The dried polymer gel is coarsely comminuted, ground by means of a three-stage roll mill and sieved off to a particle size of 150 to 700 μm. The sieving-off is effected such that at least 95% by weight of the polymer particles have a particle size of 150 to 700 μm.

TABLE 4
Process conditions for the base polymer

| | | Moisture | | | |
|---|---|---|---|---|---|
| | | content | T | v | Humidity |
| Example | Zone | [% by wt.] | [° C.] | [m/s] | [g/kg] |
| 14*) | 1 | 50 | 198 | 2.0 | 350 |
| | 2 | 42 | 198 | 2.0 | 350 |
| | 3 | 34 | 198 | 2.0 | 350 |
| | 4 | 27 | 170 | 2.0 | 75 |
| | 5 | 22 | 170 | 2.0 | 75 |
| | 6 | 19 | 170 | 2.0 | 75 |
| | 7 | 15 | 170 | 2.0 | 75 |
| | 8 | 13 | 170 | 2.0 | 75 |
| | 9 | <10 | 170 | 2.0 | 75 |
| | 10 | <5 | 80 | 2.0 | 75 |
| 15*) | 1 | 49 | 198 | 2.0 | 350 |
| | 2 | 43 | 198 | 2.0 | 350 |
| | 3 | 35 | 198 | 2.0 | 350 |
| | 4 | 28 | 170 | 2.0 | 300 |
| | 5 | 24 | 170 | 2.0 | 250 |
| | 6 | 19 | 170 | 2.0 | 200 |
| | 7 | 14 | 170 | 2.0 | 200 |
| | 8 | 13 | 170 | 2.0 | 100 |
| | 9 | <10 | 170 | 2.0 | 100 |
| | 10 | <5 | 80 | 2.0 | 75 |
| 16*) | 1 | 49 | 198 | 2.0 | 90 |
| | 2 | 40 | 198 | 2.0 | 90 |
| | 3 | 33 | 198 | 2.0 | 90 |
| | 4 | 28 | 170 | 2.0 | 300 |
| | 5 | 24 | 170 | 2.0 | 300 |
| | 6 | 19 | 170 | 2.0 | 300 |
| | 7 | 13 | 170 | 2.0 | 300 |
| | 8 | 10 | 170 | 2.0 | 300 |
| | 9 | <10 | 170 | 2.0 | 300 |
| | 10 | <5 | 80 | 2.0 | 75 |
| 17 | 1 | 50 | 140 | 2.0 | 350 |
| | 2 | 42 | 140 | 2.0 | 350 |
| | 3 | 36 | 140 | 2.0 | 350 |
| | 4 | 32 | 150 | 2.0 | 350 |
| | 5 | 27 | 150 | 2.0 | 350 |
| | 6 | 18 | 150 | 2.0 | 75 |
| | 7 | 14 | 150 | 2.0 | 75 |
| | 8 | 11 | 150 | 2.0 | 75 |
| | 9 | <10 | 150 | 2.0 | 75 |
| | 10 | <5 | 80 | 2.0 | 75 |
| 18 | 1 | 49 | 140 | 1.0 | 350 |
| | 2 | 43 | 140 | 1.0 | 350 |
| | 3 | 38 | 140 | 1.0 | 350 |
| | 4 | 34 | 150 | 2.0 | 350 |
| | 5 | 26 | 150 | 2.0 | 350 |
| | 6 | 19 | 150 | 2.0 | 350 |
| | 7 | 15 | 150 | 2.0 | 75 |
| | 8 | 12 | 150 | 2.0 | 75 |
| | 9 | <10 | 150 | 2.0 | 75 |
| | 10 | <5 | 80 | 2.0 | 75 |

Moisture content moisture content of the polymer gel at the start of the zone
T temperature of the dry air
v speed of the dry air
Humidity humidity of the dry air
*)comparative example

In examples 14 to 17, a loose polymer gel layer was obtained. In the case of a loose layer, there is the risk that dry air will bypass the polymer gel particles in random channels. In example 18, the relatively low speed of the dry air right at the start of the drying together with the relatively low temperature of the drying gas led to a dense polymer gel layer.

TABLE 5
Properties of the base polymer

| | CRC | AUL | Extractables |
|---|---|---|---|
| Example | [g/g] | [g/g] | [% by wt.] |
| 14*) | 37.6 | 11.5 | 14.5 |
| 15*) | 38.3 | 11.0 | 14.5 |
| 16*) | 35.8 | 12.9 | 12.8 |
| 17 | 34.4 | 24.7 | 8.5 |
| 18 | 35.3 | 23.1 | 10.4 |

*)comparative example

### Surface Postcrosslinking

1.2 kg of classified polymer particles is coated in a VT 5R-MK plowshare mixer with heating jacket (from Lödige Maschinenbau GmbH; Paderborn, Germany) at 23° C. and a shaft speed of 200 revolutions per minute by means of a two-phase spray nozzle with a mixture of 1.41% by weight of isopropanol, 3.13% by weight of water, 0.07% by weight of N-hydroxyethyl-2-oxazolidinone, 0.07% by weight of propane-1,3-diol and 0.5% by weight of aluminum lactate (solution A) or a mixture of 3.0% by weight of water, 1.5% by weight of propane-1,2-diol and 0.04% by weight of ethylene glycol diglycidyl ether (solution B), based in each case on the polymer particles used. For solution A, classified polymer particles having a particle size of 100 to 600 μm were used. For solution B, classified polymer particles having a particle size of 300 to 600 μm were used. The exact conditions of the individual examples can be found in table 6.

After the spray application, the product temperature is increased to 185° C. (solution A) or 160° C. (solution B) and the reaction mixture is held at this temperature and a shaft speed of 50 revolutions per minute for 45 minutes (solution A) or 30 minutes (solution B). The resulting product is cooled to ambient temperature and classified again with a 700 μm sieve. The fraction with a particle size of less than 700 μm is analyzed. The results are entered in table 6.

TABLE 6
Process conditions and results of the surface postcrosslinking

| | | | | | | SFC | Remos |
|---|---|---|---|---|---|---|---|
| | | CRC | AUHL | T20 | VAUL | [10⁻⁷ | [% by |
| Example | Solution | [g/g] | [g/g] | [s] | [s] | cm³s/g] | wt.] |
| 14*) | A | 26.8 | 24.6 | 190 | | 23 | 0.054 |
| 14*) | B | 34.5 | 22.1 | | 260 | 5 | 0.039 |
| 15*) | A | 26.4 | 24.3 | 198 | | 28 | 0.052 |
| 15*) | B | 34.8 | 21.5 | | 254 | 4 | 0.040 |
| 16*) | A | 25.9 | 24.0 | 210 | | 20 | 0.073 |
| 16*) | B | 33.2 | 23.4 | | 239 | 8 | 0.060 |
| 17 | A | 30.0 | 26.9 | 105 | | 31 | 0.050 |
| 17 | B | 31.3 | 25.6 | | 193 | 25 | 0.046 |
| 18 | A | 30.9 | 27.1 | 109 | | 34 | 0.050 |
| 18 | B | 30.4 | 26.5 | | 203 | 31 | 0.030 |

Remos residual monomer
*)comparative example

1. A process for producing surface postcrosslinked superabsorbent particles by polymerizing an aqueous monomer solution or suspension comprising
a) at least one ethylenically unsaturated monomer which bears an acid group and is at least partly neutralized,
b) at least one crosslinker and
c) at least one initiator,
by polymerizing the aqueous monomer solution or suspension to give a polymer gel, extruding the resultant polymer gel through a die plate, drying the extruded polymer gel in an air circulation belt drier having one or more zones, and grinding and classifying and then thermally surface postcrosslinking the resulting polymer particles, wherein not more than 0.14% by weight of the at least one initiator c), based on monomer a), is used prior to the neutralization, a temperature of the drying gas supplied in forward zones of the air circulation belt drier is from 120 to 160° C. for at least 50% of a total dwell time, and speeds of the drying gas supplied in the forward zones of the air circulation belt drier are from 1.2 to 3.0 m/s for at least 20% of the total dwell time, where the forward zones of the air circulation belt drier are the zones in the air circulation belt drier where a moisture content of the polymer gel to be dried is more than 20% by weight at least at the start of a respective zone.

2. The process according to claim 1, wherein the speeds of the drying gas supplied in the forward zones of the air circulation belt drier are additionally from 0.1 to 1.15 m/s for 10% to 80% of the total dwell time in the forward zones, where the zones having lower speeds are upstream of the zones having higher speeds.

3. The process according to claim 1, wherein the speeds of the drying gas supplied in the forward zones of the air circulation belt drier are additionally from 0.7 to 1.00 m/s for 25% to 50% of the total dwell time in the forward zones, where the zones having lower speeds are upstream of the zones having higher speeds.

4. The process according to claim 1, wherein a steam content of the drying gas supplied in the forward zones of the air circulation belt drier is at least 200 g per kg of dry drying gas.

5. The process according to claim 1, wherein the thermal surface postcrosslinking is performed at a maximum temperature of at least 180° C.

6. The process according to claim 1, wherein not more than 0.04% by weight of the at least one initiator c) is used, based on monomer a) prior to neutralization.

7. The process according to claim 1, wherein the temperature of the drying gas supplied in the forward zones of the air circulation belt drier is from 135 to 145° C. for at least 80% of the total dwell time in the forward zones.

8. The process according to claim 1, wherein the speed of the drying gas supplied in the forward zones of the air circulation belt drier is from 1.5 to 2.4 m/s for at least 50% of the total dwell time in the forward zones.

9. The process according to claim 1, wherein the forward zones of the air circulation belt drier are the zones of the air circulation belt drier where a moisture content of the polymer gel to be dried is more than 32% by weight at least at the start of the respective zone.

10. The process according to claim 1, wherein a temperature of the polymer gel in the course of extrusion is from 70 to 125° C.

11. The process according to claim 1, wherein a temperature of the polymer gel in the course of extrusion is from 90 to 105° C.

12. The process according to claim 1, wherein a moisture content of the polymer gel in the course of extrusion is from 20% to 70% by weight.

13. The process according to claim 1, wherein a moisture content of the polymer gel in the course of extrusion is from 40% to 60% by weight.

14. The process according to claim 1, wherein hole openings in the die plate have a diameter of 2 to 20 mm.

15. The process according to claim 1, wherein hole openings in the die plate have a length of 15 to 45 mm.
